(19) United States
(12) Patent Application Publication
(10) Pub. No.: US 2018/0026720 A1
(43) Pub. Date: Jan. 25, 2018

(54) Frequency Domain Equalization Method

(71) Applicant: Shanghai Jiao Tong University, Shanghai (CN)

(72) Inventors: Lilin Yi, Shanghai (CN); Lei Xue, Shanghai (CN); Honglin Ji, Shanghai (CN); Weisheng Hu, Shanghai (CN); Qi Yang, Wuhan (CN)

(21) Appl. No.: 15/654,198

(22) Filed: Jul. 19, 2017

(30) Foreign Application Priority Data
Jul. 20, 2016 (CN) 201610575363.7

(51) Int. Cl. H04B 10/2513; G02B 6/293; G02B 6/12

(52) U.S. Cl. CPC H04B 10/25133; G02B 6/12007; G02B 6/29376; G02B 6/1228

(57) ABSTRACT

The present invention discloses a frequency domain equalization method, including transmitting an optical signal transmitted over a long distance to a dispersion compensation device, and performing dispersion compensation and equalization processing on the optical signal through the dispersion compensation device. The present invention utilizes the compensation effect of a single dispersion compensation device to realize dispersion compensation and frequency equalization on the optical signal, reducing the bandwidth requirements for the devices at the emitting and receiving ends, allows the directly modulated laser to still support long-distance fiber transmission in the case of high-speed signal modulation, and greatly reduces the system cost. In addition, transmissions over different distances can be supported by changing the value for the dispersion amount, so that the distance can be adjusted flexibly according to the requirements in the data center or other application scenarios.

### FIELD OF THE INVENTION

The present invention relates to the field of optical fiber communication, and in particular to a frequency domain equalization method.

### DESCRIPTION OF THE PRIOR ART

With the popularity and development of the Internet, communication data traffic increases year by year, the connection rate between core network and access network urgently needs to be upgraded to 100 Gb/s, and the bandwidth bottleneck transfers to metropolitan area networks. The increase in the capacity of point-to-point systems can usually be achieved in two ways, namely, increasing the number of wavelengths and raising the single-wavelength rate, wherein the raising of the single-wavelength rate can support higher transmission rates, which requires the emitting and receiving devices to support higher modulation and receiving rates. The raising of the single-wavelength rate involves two types of technology: (1) photoelectric modulation, photoelectric detection devices with a high bandwidth; and (2) modulation formats with high spectrum efficiency. There are several common ways to realize high-speed signal modulation with narrow bandwidth devices as follows.

(1) A high-order modulation format is used, which increases the number of bits carried by a single symbol through the use of a high-order modulation code to improve the bandwidth efficiency and reduce the bandwidth requirements for the modulating and receiving devices.

In 2016, Wuhan Post and Telecommunication Technologies Co., Ltd., published an article entitled “Transmission of 4×28-Gb/s PAM-4 over 160-km single mode fiber using 10G-Class DML and Photodiode” at the Optical Fiber Communication Conference. The authors demonstrated that modulation and demodulation of a single wavelength 28 Gb/s signal based on four-level pulse amplitude modulation (4-PAM) format is realized with a 10 GHz device. In the scheme according to this document, the modulation device is a commercial 10 GHz directly modulated laser (DML). Due to the limited bandwidth of the device, it is necessary to perform equalization processing on the signal using off-line digital signal processing (DSP) technology at the signal receiving end and to perform compensation on the dispersion accumulated during fiber transmission, and demodulation of the 4-PAM signal also needs off-line DSP processing, so overall, the technology is complex, and the cost is high. Since there are no real-time high-speed DSP chips at present, they cannot be actually commercially used.

(2) In addition to PAM-4, duobinary modulation and discrete multi-tone (DMT) modulation are also commonly used high-order modulation methods. Since the bandwidth of the high-order modulation code is lower than that of the binary code, anti-dispersion ability of these modulation methods is stronger under the modulation of a narrow bandwidth device.

In 2015, K. Zhong et al., published an article entitled “Experimental study of PAM-4, CAP-16, and DMT for 100 Gb/s short reach optical transmission systems” in Optical Express. The advantages and disadvantages and complexity of three high-order modulation formats in 100 Gb/s short reach transmission systems are compared in this article. The experiment uses EML with a 3 dB bandwidth of 20 GHz and a receiver with a bandwidth of 30 GHz, and off-line digital signal processing is performed after receiving signals, but the overall cost is too high. In 2015, D. Van Veen et al., published another article entitled “Demonstration of 40-Gb/s TDM-PON Over 42-km With 31 dB Optical Power Budget Using an APD-Based Receiver” in IEEE Journal of Lightwave Technology. It is proposed in this article that, a narrowband modulator is used to realize high-speed duobinary modulation, the OOK is converted to the duobinary code through a low-pass filter at the emitting end, and the receiving end in this scheme still needs a broadband receiver. The experiment demonstrated the fiber transmission of the 40-Gb/s signal over 26 km difference distance in the C-band. Although the outer modulation method with a small chirp coefficient is used, it is still necessary to use FBG for dispersion pre-compensation, and to compensate different dispersion amount for different transmission distances.

(3) The frequency equalization technology is used to improve the modulation bandwidth. This modulation method improves the modulation bandwidth of the device or improves the modulation rate of the device.

F. Karinou et al., published an article entitled “Toward cost-efficient 100G metro networks using IM/DD, 10 GHz components, and MLSE receiver” (based on 10 GHz) in Journal of Lightwave Technology. It is proposed in this article that, signal pre-distortion is used to compensate for the signal degradation caused by the narrow bandwidth of the emitter and to use the MLSE (Maximum Likelihood Sequence Estimation) of electricity in the receiver to compensate for the fiber dispersion and signal inter-code interference caused by the narrow bandwidth of the receiver, thereby realizing the 28 Gbs OOK modulation based on TSOA with a 10 GHz bandwidth. Although the scheme reduces the bandwidth requirements for emitters and receivers, it is necessary to perform complex DSP processing on the signal, and the maximum supported transmission distance can only reach 80 km. S. H. Bae et al., published an article entitled “Transmission of 51.56-Gb/s OOK signal over 15 km of SSMF using direct-modulated 1.55-μm DFB laser” at the Optical Fiber Communication Conference. The authors demonstrated a 51.56-Gb/s OOK signal modulated with a 25.6 GHz directly modulated laser is transmitted over 15 km. Since the chirp of the directly modulated laser is large, the authors improved the chirp by optimizing the extinction ratio of the OOK signal and performed off-line DSP processing using a duobinary filter and a feed forward equalizer (FFE) at the receiving end to compensate for fiber dispersion and limited system bandwidth. With the scheme according to this article, it is necessary to perform off-line digital signal processing, it cannot be presently applied in real time, the transmission distance is limited, and it cannot be used for long-distance point to point transmission.

Taking into account such factors as cost and performance, when raising the capacity of an optical fiber communication system by raising the single wavelength rate, different types of optical networks usually use different schemes for signal transmission. For a high-speed optical signal, pulse spreading will occur because of the effect of fiber dispersion during optical fiber transmission, resulting in signal degradation. Therefore, for cost-sensitive systems such as short-distance interconnection and access networks, how to use low-cost devices and simple modulation and demodulation technologies to achieve high-speed signal modulation and dispersion management for a high-speed signal so that it can support long-distance fiber transmission has become an urgent problem that needs to be solved.

### SUMMARY OF THE INVENTION

In view of the above-mentioned drawbacks of the prior art, the technical problem to be solved by the present invention is how to realize high-speed signal modulation and long-distance transmission with low-cost devices and simple modulation and demodulation technologies when raising the capacity of an optical fiber communication system by raising the single-wavelength rate.

In order to achieve the above-mentioned object, a preferred embodiment of the present invention provides a frequency domain equalization method including transmitting an optical signal transmitted over a long distance to a dispersion compensation device and performing dispersion compensation and equalization processing on the optical signal through the dispersion compensation device.

Further, the compensation amount of the dispersion compensation device is the sum of a compensation value for an optical fiber dispersion amount and an over-compensated dispersion amount.

Further, the compensation value for the fiber dispersion amount is −2720 ps/nm, and the over-compensated dispersion amount is −100˜-200 ps/nm. Preferably, the over-compensated dispersion amount is −150 ps/nm.

Further, the dispersion compensation device is a dispersion compensation device capable of performing dispersion compensation on the transmitted signal band.

Further, the dispersion compensation device is a dispersion compensation device with a fixed dispersion value.

Further, the number of dispersion compensation devices is one.

Further, the frequency domain equalization method further includes performing, by a signal emitting means, optical modulation on a high-speed signal to obtain a modulated optical signal, and the modulated optical signal will be transmitted over the long distance.

Further, the signal emitting means realizes the optical modulation of the high-speed signal by current modulation.

Further, the signal emitting means is a directly modulated laser.

Further, the bandwidth of the directly modulated laser is 10 GHz.

Further, the high-speed signal loaded on the directly modulated laser is a binary signal at a rate of 25 Gb/s.

Further, the transmission over a long distance refers to a transmission through an optical fiber.

Further, the optical fiber is a single mode fiber, the dispersion coefficient of the optical fiber in the C-band is 17 ps/nm/km, and the length of the optical fiber is 160 km.

Further, the frequency domain equalization method further includes receiving, by a signal receiving means, a dispersion compensated and equalization processed optical signal.

Further, the signal receiving means is a photoelectric detector with a bandwidth of 10 GHz.

Further, the signal emitting means is a narrowband device or a broadband device, and the signal receiving means is a narrowband device or a broadband device. The signal emitting means and the signal receiving means can be any combination of a narrowband device and a broadband device according to the actual requirements.

A preferred embodiment of the present invention provides a frequency domain equalization method including steps as follows:

step 1, performing, by a signal emitting means, optical modulation on a high-speed signal to obtain a modulated optical signal;

step 2, transmitting, through an optical fiber, the modulated optical signal to a dispersion compensation device, and performing dispersion compensation and equalization processing to obtain a compensated and equalized optical signal, the compensation amount of the dispersion compensation device is the sum of a compensation value for an optical fiber dispersion amount and an over-compensated dispersion amount; and

step 3: receiving, by a signal receiving means, the compensated and equalized optical signal.

Further, the compensation value for the fiber dispersion amount is −2720 ps/nm, and the over-compensated dispersion amount is −100˜-200 ps/nm.

Further, the dispersion compensation device is a dispersion compensation device capable of performing dispersion compensation on the transmitted signal band. The number of the dispersion compensation devices is one.

Further, the dispersion compensation device is a dispersion compensation device with a fixed dispersion value.

Further, in step 1, the bandwidth of the directly modulated laser is 10 GHz, the high-speed signal loaded on the directly modulated laser is a binary signal at a rate of 25 Gb/s, and the modulation of the signal is realized by current modulation.

Further, in step 2, the optical fiber is a single mode fiber, the dispersion coefficient of the optical fiber in the C-band is 17 ps/nm/km, and the length of the optical fiber is 160 km.

Further, the signal emitting means realizes the optical modulation of the high-speed signal by current modulation. Preferably, the signal emitting means is a directly modulated laser, and the bandwidth of the directly modulated laser is 10 GHz.

Unlike the existing technologies such as high-order modulation and electrical dispersion compensation, the working principle of the present invention is:

in terms of frequency equalization, since the narrowband device has a good response to low frequency and a weak response to high frequency, the high frequency spectrum components will be greatly attenuated when the high-speed signal modulation is performed by it, so that the spectrum components of the modulated signal are changed, and thus good modulation effect cannot be obtained, therefore, the present invention proposes to use the high-frequency boosting effect of the single dispersion compensation device in the case of dispersion over-compensation so that the high and low frequency components of the signal are equalized, thereby improving the modulation effect.

The present invention has the beneficial effects as follows.

(1) An optical dispersion compensation device is used to realize dispersion compensation and frequency equalized all-optical signal processing, avoiding the use of a high-speed electric dispersion compensation module and an electric frequency equalization algorithm.

The existing frequency domain equalization is mainly to equalize on the electricity by algorithm, which is the means from wireless communication and digital communication, because in both cases, there is no such a compression effect between the transmitted channel and signal. The compensation can only be performed in the electrical domain. Furthermore, in the optical fiber communication, the chirp of the directly modulated laser is generally considered as a factor that can degrade the signal, so the mainstream idea is to find a solution about how to suppress the chirp.

Since the effect of the dispersion generated by the fiber channel on the signal is different from the fading of the wireless channel on the signal, and the effects of the dispersion and the chirp of the directly modulated laser on the pulse only exist on the light, they can be used. The present invention performs equalization processing on the light, reducing the complexity of processing on the electricity.

(2) An optical dispersion compensation device is used to reduce the requirements of bandwidth from the system to the emitter and receiver and make the directly modulated laser support the optical fiber transmission distance of 160 km, effectively reducing the system cost.

(3) The invention can be realized directly on the traditional 10 Gb/s system, and the high-speed modulation of 25 Gb/s can be realized without changing system architecture, thereby realizing a smooth upgrade of the system.

The concepts, the specific structures and the technical effects of the present invention will be described further below in conjunction with the accompanying drawings, in order to fully understand the objects, features and effects of the present invention.

### BRIEF DESCRIPTION OF THE DRAWINGS

FIG. 1 is a flow chart of a frequency domain equalization method according to a preferred embodiment of the present invention;

FIG. 2 is a graph of the error rates obtained by keeping the received power constant and changing the over-compensated dispersion value in the cases of BTB, 100 km, and 160 km according to a preferred embodiment of the present invention;

FIG. 3 is a graph of the frequency response of the system before and after dispersion compensation for a direct optical signal which is not transmitted through optical fiber according to Embodiment 1 of the present invention;

FIG. 4 is a graph of the frequency response of the system before and after dispersion compensation for the optical signal which is transmitted over 160 km optical fiber according to Embodiment 1 of the present invention;

FIG. 5 is an eye diagram corresponding to the directly modulated optical signal before dispersion compensation according to Embodiment 1 of the present invention;

FIG. 6 is an eye diagram corresponding to the directly modulated optical signal after dispersion compensation according to Embodiment 1 of the present invention;

FIG. 7 is an eye diagram corresponding to the optical signal which is not subjected to dispersion compensation after transmission over 160 km optical fiber according to Embodiment 1 of the present invention; and

FIG. 8 is an eye diagram corresponding to the optical signal which is subjected to dispersion compensation after transmission over 160 km optical fiber according to Embodiment 1 of the present invention.

### DETAILED DESCRIPTION OF THE PREFERRED EMBODIMENTS

The present invention is described in further detail below in conjunction with the accompanying drawings and with reference to the data. It is to be understood that the implementations are merely illustrative of the present invention and are not intended to limit the scope of the invention in any way.

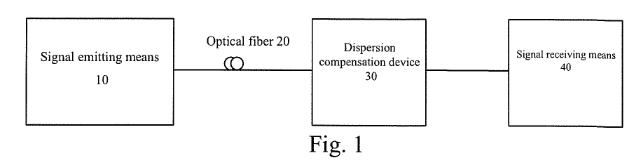

As shown in FIG. 1, a preferred embodiment of the present invention provides a frequency domain equalization method based on dispersion over-compensation, including the steps as follows.

Step 1: performing, by a signal emitting means 10, optical modulation on a high-speed signal to obtain a modulated optical signal.

In a preferred embodiment, the signal emitting means 10 is a directly modulated laser with a bandwidth of 10 GHz, and the high-speed signal loaded on the directly modulated laser is a binary signal at a rate of 25 Gb/s, the directly modulated laser realizes modulation of the signal by current modulation.

Step 2: transmitting, through an optical fiber 20, the modulated optical signal to a dispersion compensation device 30 capable of performing dispersion compensation on the transmitted signal band, and performing dispersion compensation and equalization processing, and the compensated and equalized optical signal is obtained.

In a specific embodiment, the dispersion compensation device 30 is a dispersion compensation device with a fixed dispersion value. The amount of compensation of the dispersion compensation device 30 is the sum of the compensation value for the fiber dispersion amount and the over-compensated dispersion amount. In a preferred embodiment, the optical fiber 20 is a single mode fiber, the dispersion coefficient thereof in the C-band is 17 ps/nm/km, and the length thereof is 160 km.

Step 3: receiving, by a signal receiving means 40, the compensated and equalized optical signal.

In a preferred embodiment, the signal receiving means is a photoelectric detector with a bandwidth of 10 GHz.

Unlike the existing technologies such as high-order modulation and electrical dispersion compensation, the working principle of the present embodiment is:
in terms of frequency equalization, since the narrowband device has a good response to low frequency and a weak response to high frequency, the high frequency spectrum components will be greatly attenuated when the high-speed signal modulation is performed by it, so that the spectrum components of the modulated signal are changed, and thus good modulation effect cannot be obtained, and therefore, this embodiment proposes to use the high-frequency boosting effect of the single dispersion compensation device in the case of dispersion over-compensation so that the high and low frequency components of the signal are equalized, thereby improving the modulation effect.

The spectrum components of the dispersion over-compensated optical signal are changed, so that the characteristics of the signal is changed and the high frequency of the signal is boosted, thereby realizing the high-speed modulation and long-distance transmission of the narrowband device, on the condition that the dispersion compensation device 30 can realize dispersion compensation for the signal in the transmission band without other performance requirements.

In order to confirm the feasibility of the technology, it will be described in connection with specific embodiments:

### Embodiment 1

In this embodiment, the signal emitting means 10 is a directly modulated laser (DML), the bandwidth of the directly modulated laser is 10 GHz, the signal loaded on the laser is a binary signal at a rate of 25 Gb/s, and the modulation of the signal can be realized by current modulation.

The optical fiber 20 is an ordinary single mode fiber, the dispersion coefficient thereof in the C-band is 17 ps/nm/km, and the length thereof is 160 km.

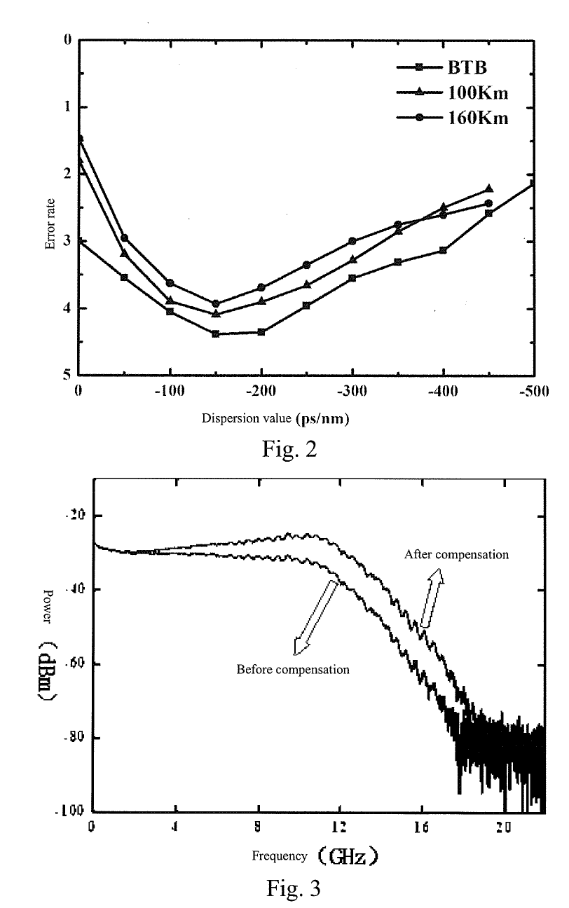

The dispersion compensation device 30 is a dispersion compensation fiber (DCF) in which the compensation range includes the C-band and the dispersion amount is fixed, and the amount of compensation of the dispersion compensation device 30 is the sum of the compensation value for the fiber dispersion amount of −2720 ps/nm and the over-compensated dispersion amount of −150 ps/nm, totaling −2870 ps/nm. The compensation value for the fiber dispersion amount is the compensation value calculated from the transmission distance, and the optimal over-compensated dispersion value is achieved by ensuring the power at the receiving end constant in the cases of BTB, 100 km, and 160 km, changing the over-compensated dispersion amount in the range of 0 ps/nm to −500 ps/nm after compensating the dispersion of the optical fiber, recording the error codes in each case, and finding the corresponding dispersion over-compensated value when the error code is a minimum, which is the optimal over-compensated dispersion value. As shown in FIG. 2, the experiments found that although the compensation values for the fiber dispersion amount under various transmission distances are not consistent, the optimal value for the over-compensated dispersion amount of −150 ps/nm remains unchanged, and there is a good compensation effect in the case of −100˜-200 ps/nm, thus having a certain dispersion capacity.

In this embodiment, the signal receiving means 40 is a photoelectric detector with a bandwidth of 10 GHz.

The transmission path of the high-speed signal is that: the high-speed NRZ signal at a rate of 25 Gb/s is firstly modulated onto the signal emitting means 10, the modulated optical signal enters into the optical fiber 20 for long-distance transmission, then is subjected to dispersion compensation and equalization processing by the dispersion compensation device 30 connected to the other end of the optical fiber 20, and finally is subjected to signal detection by the signal receiving means 40 connected to the dispersion compensation device 30.

FIG. 3 is a graph of the frequency response of the system before and after dispersion compensation for a direct optical signal which is not transmitted through optical fiber according to this embodiment. Since the frequency domain equalization caused by the dispersion compensation boosts the high frequency components of the signal, the magnitude of the boosting of the high frequency is associated with the dispersion value for over-compensation. Therefore, the best boosting effect is found by setting different dispersion compensation values.

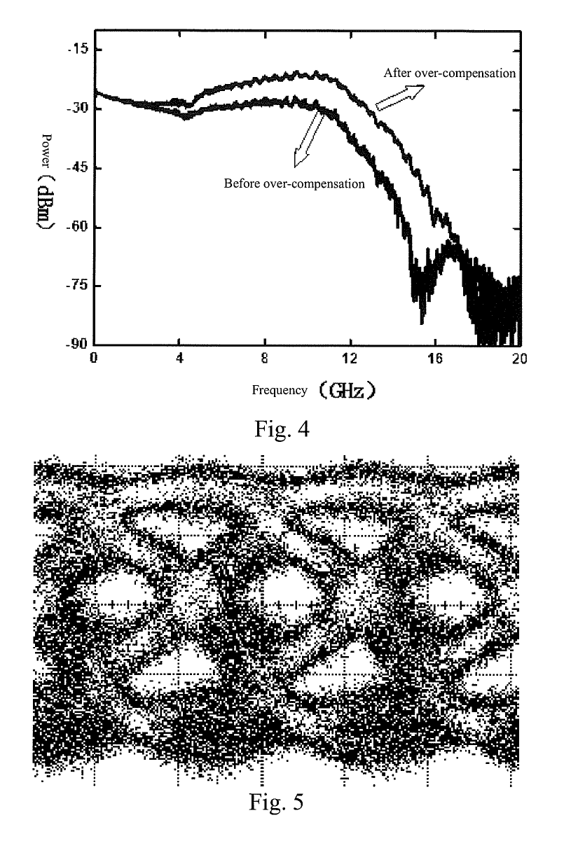

FIG. 4 is a graph of the frequency response of the system before and after dispersion compensation for the optical signal which is transmitted over 160 km optical fiber according to this embodiment. It can be seen from FIG. 4 that the high frequency of the system after compensation is boosted, reducing the signal quality fading caused by the narrowband device at the emitting and receiving ends.

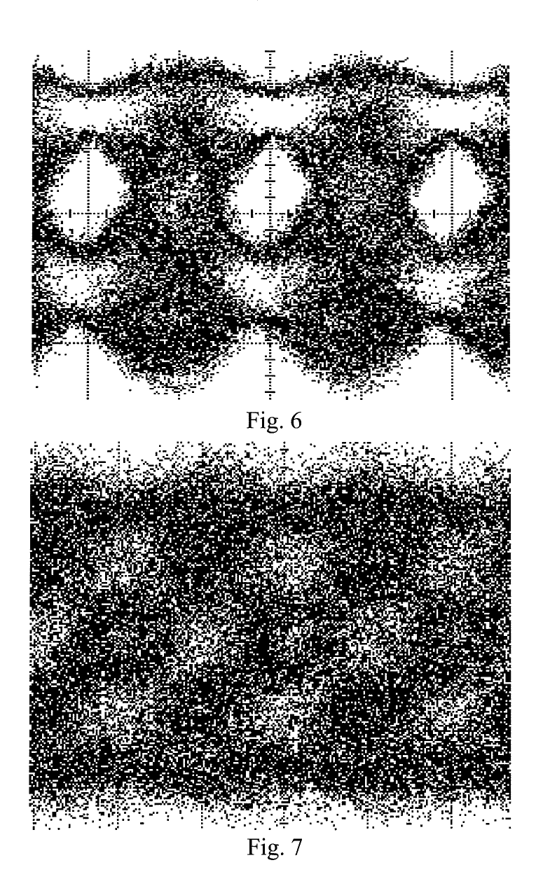

FIG. 5 and FIG. 6 are eye diagrams corresponding to the directly modulated optical signal before and after dispersion compensation, respectively. It can be seen, by comparison, that after the original high-speed signal is modulated onto the narrowband device and is detected via a narrowband receiver, the high frequency components of the optical signal are very low, and the middle eyes are not very clear (FIG. 5). The deteriorated high-frequency components of the compensated optical signal are improved, achieving the effect of frequency equalization, so that the middle eyes are open (FIG. 6). It can be seen from FIG. 5 and FIG. 6 that the middle eyes in the eye diagram after over-compensation become significantly larger and clearer, so that the decision at the receiving end is more accurate.

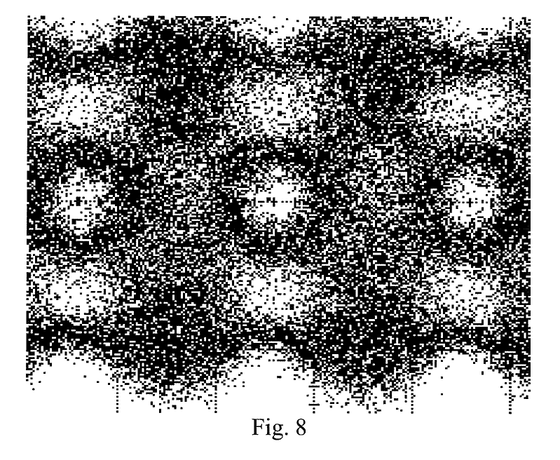

FIG. 7 is an eye diagram corresponding to the optical signal which is not subjected to dispersion compensation after transmission over 160 km optical fiber according to this embodiment. It can be seen that after the high-speed directly modulated optical signal is transmitted over the long-distance optical fiber, a decidable eye diagram cannot be obtained due to dispersion. FIG. 8 is an eye diagram corresponding to the optical signal which is subjected to dispersion compensation after transmission over 160 km optical fiber according to this embodiment. It can be seen that after the long-distance transmission, the dispersion over-compensation scheme can obtain a decidable eye diagram. In summary, the optical dispersion over-compensation cannot only realize dispersion compensation, but also has the effect of frequency equalization.

This embodiment utilizes the compensation effect of a single dispersion compensation device to realize dispersion compensation and frequency equalization on the optical signal, reduces the bandwidth requirements for the devices at the emitting and receiving ends, allows the directly modulated laser to still support long-distance fiber transmission in the case of high-speed signal modulation, and greatly reduces the system cost. In addition, transmissions over different distances can be supported by changing the value for the dispersion amount, so that the distance can be adjusted flexibly according to the requirements in the data center or other application scenarios.

The preferred specific embodiments of the present invention have been described in detail above. It is to be understood that numerous modifications and variations can be made by those ordinary skilled in the art in accordance with the concepts of the present invention without any inventive effort. Hence, the technical solutions that can be derived by those skilled in the art according to the concepts of the present invention on the basis of the prior art through logical analysis, reasoning and limited experiments should be within the scope of protection defined by the claims.

1. A frequency domain equalization method, comprising transmitting an optical signal transmitted over a long distance to a dispersion compensation device, and performing dispersion compensation and equalization processing on the optical signal through the dispersion compensation device.

2. The frequency domain equalization method according to claim 1, wherein the compensation amount of the dispersion compensation device is the sum of a compensation value for an optical fiber dispersion amount and an over-compensated dispersion amount.

3. The frequency domain equalization method according to claim 2, wherein the compensation value for the fiber dispersion amount is −2720 ps/nm, and the over-compensated dispersion amount is −100˜-200 ps/nm.

4. The frequency domain equalization method according to claim 1, wherein the dispersion compensation device is a dispersion compensation device capable of performing dispersion compensation on the transmitted signal band.

5. The frequency domain equalization method according to claim 1, wherein the dispersion compensation device is a dispersion compensation device with a fixed dispersion value.

6. The frequency domain equalization method according to claim 1, wherein the number of the dispersion compensation devices is one.

7. The frequency domain equalization method according to claim 1, wherein the frequency domain equalization method further comprises performing, by a signal emitter, optical modulation on a high-speed signal to obtain a modulated optical signal, and the modulated optical signal will be transmitted over the long distance.

8. The frequency domain equalization method according to claim 7, wherein the signal emitter realizes the optical modulation of the high-speed signal by current modulation.

9. The frequency domain equalization method according to claim 8, wherein the signal emitter is a narrowband device or a broadband device.

10. The frequency domain equalization method according to claim 8, wherein the signal emitter is a directly modulated laser.

11. The frequency domain equalization method according to claim 10, wherein the bandwidth of the directly modulated laser is 10 GHz.

12. The frequency domain equalization method according to claim 8, wherein the high-speed signal loaded on the directly modulated laser is a binary signal at a rate of 25 Gb/s.

13. The frequency domain equalization method according to claim 1, wherein the transmission over a long distance refers to a transmission through optical fiber.

14. The frequency domain equalization method according to claim 13, wherein the optical fiber is a single mode fiber, the dispersion coefficient of the optical fiber in the C-band is 17 ps/nm/km, and the length of the optical fiber is 160 km.

15. The frequency domain equalization method according to claim 1, wherein the frequency domain equalization method further comprises receiving, by a signal receiver, a dispersion compensated and equalization processed optical signal.

16. The frequency domain equalization method according to claim 15, wherein the signal receiver is a photoelectric detector with a bandwidth of 10 GHz.

17. The frequency domain equalization method according to claim 15, wherein the signal receiver is a narrowband device or a broadband device.

18. A frequency domain equalization method, comprising steps as follows:
step 1, performing, by a signal emitter, optical modulation on a high-speed signal to obtain a modulated optical signal;
step 2, transmitting, through an optical fiber, the modulated optical signal to a dispersion compensation device, and performing dispersion compensation and equalization processing to obtain a compensated and equalized optical signal, the compensation amount of the dispersion compensation device is the sum of a compensation value for an optical fiber dispersion amount and an over-compensated dispersion amount;
step 3: receiving, by a signal receiver, the compensated and equalized optical signal.

19. The frequency domain equalization method according to claim 18, wherein the compensation value for the fiber dispersion amount is −2720 ps/nm, and the over-compensated dispersion amount is −100˜-200 ps/nm.

20. The frequency domain equalization method according to claim 18, wherein the dispersion compensation device is a dispersion compensation device capable of performing dispersion compensation on the transmitted signal band.
